(19) United States
(12) Patent Application Publication
(10) Pub. No.: US 2004/0023002 A1
(43) Pub. Date: Feb. 5, 2004

(54) Ultimate drywall tape

(76) Inventors: Edward Wyndham, Manor, TX (US); Nadeen Lona-Ann Wyndham-Omar, Manor, TX (US)

Correspondence Address: Edward Wyndham, 10912 Parsons Road, Manor, TX, 78653, US

(21) Appl. No.: 10/209,068

(22) Filed: Jul. 30, 2002

(51) Int. Cl. B32B 3/00

(52) U.S. Cl. 428/156; 428/343

(57) ABSTRACT

A tape for seam in drywall construction comprising an elongated paper tape member having the unique attribute to fill out the seam totally without the aid of any other filling agents by virtue of the center portion being thicker and tapers off thinner as it rises toward the flat surface of the drywall that forms the wall expanse. A self-adhesive is applied to one surface of the tape so that it can be attached permanently to the drywall seam.

### CROSS-REFERENCE TO RELATED APPLICATIONS

This document takes the place of the previous Disclosure Document #480347 filed Sep. 28, 2000 under the title The Ultimate Drywall Tape.

### BACKGROUND OF INVENTION

One of the main objects of this invention is to provide a drywall tape that is adequate as any of the prior art with additional features of utility that make it stand out among prior art. It will be the only drywall tape to fill out the entire seam when two sheets of drywall are butted to form a wall expanse. It is the only drywall tape that claims to provide strengthening element to a drywall construction. The tape is designed to serve in the same capacity as when two beveled pieces of metal are welded together. The welder starts at the closest point, i.e., where the beveled metal forms a ‘V’ type chasm. The welder fills out the entire area until it is flush with the surface of the two pieces of metal. The welder usually grinds off the extra welding residue to form a smooth flush surface making the two pieces of metal to form a bond and become one piece of metal in the similar way the tape installer will install the new tape to fill out the seam or shallow chasm formed by the two sheets of drywall. Because the self-adhesive is of such potency, the two sheets of drywall have almost become one like in the case of the welded metal. The only difference is that they are not fused together like in the case of the metal weld because the process and materials are of a different nature. With all these additional features to my new tape, there is not the least doubt that this tape is a very necessary product for the construction industry because the new tape will be taking the construction industry to an extremely higher plain doing what no other drywall tape has ever done. It fills out the entire seam independently and also adds strength to the overall wall expanse.

### FIELD AND BACKGROUND OF INVENTION

The present invention relates in general to tape for drywall construction and in particular to a new and very useful full-bodied paper tape that embodies the unique attribute to fill out the seam that is created when two sheets of drywall are butted to form a wall expanse.

With the high cost of construction, any material or technique that decreases labor cost by reducing the time it takes to finish any particular area in the process of construction would be greatly welcomed by the construction industry. Labor productivity is a variable that the construction industry has some degree of control over by employing the newest and most efficient material and tooling.

The use of drywall is widely used to construct interior walls. The term drywall will be used in this disclosure to include sheetrock, plaster board or any products which are supplied in large sheets for interior wall construction. The very first step in preparing drywall construction for painting is to apply tape to the seam. Such known tape is made of pulp paper and comes, for example, in rolls of about 250 linear feet. The tape which is about two inches wide, is used in conjunction with a wet compound or plaster and requires a great degree of skill in its application to ensure there are no wrinkles in the tape, bubbles under the tape or even layer of compound. The tape is then sanded and feathered so that when the wall is painted, there are no seams, bubbles or wrinkles showing. The foregoing process is very time consuming and requires a reasonable degree of skill. The new tape is almost 100% adequate and requires no great deal of skills to produce a professional looking job, because the tape fills out the entire seam making it very simple to finish with a very small amount of all purpose compound feathering the edge of the tape.

In addition to paper tape, open fiberglass mesh is used for the same purpose. The fiberglass mesh is first applied to the seam and the wet compound is then applied over the top of the mesh and seam. This is also a long and proactive process like in all prior arts, the tape installer has to use a vast quantity of all purpose compound which takes days sometimes to finish a taped seam, depending on weather conditions. With the new invention, the seam is finished the same day because the small amount of all purpose compound it takes to taper off the edge of the tape is so thin, it dries in minutes not hours, and if the wall is to be textured, it is so very thin, it should not show any imperfections after texturing.

Therefore, we conclude that the Ultimate drywall Tape is the answer for all our drywall needs.

### BRIEF SUMMARY OF THE INVENTION

The present invention is a full bodied drywall tape which is none perforated, made of paper or other porous material which is compatible with drywall compound and which has on one side, thereof, a layer of self-sticking adhesive that is potent enough to make a permanent bond with the drywall seam. The layer of adhesive is covered by a backing to avoid the sticking of the tape to itself and at the same time, easily peeled off to expedite its installation.

The tape of the present invention can be adhered by low skilled persons and still produce professional look. This invention provides a time saving of about 50-65%, and can be used by homeowners and unskilled labor instead of requiring the skill of a master craftsman as in the prior art technique.

The tape must be porous and has a solid finish without perforations, yet very flexible and has a thicker center portion which fills out the seam independently. The tape may be made by molding paper pulp that conforms to the shape of the tape through a mold. It may be made by gluing several layers of paper or a mixture of compatible materials with paper through a mold that conforms to the shape of the tape. The tape should be crafted with a fairly inexpensive grade of paper that will maintain consistent strength throughout the entire roll.

The newly invented tape will automatically create a much stronger seam than prior art by virtue of the thicker middle portion which bonds the drywall sheets together making for an overall more superior wall expanse in strength than prior art.

### BRIEF DESCRIPTION OF THE SEVERAL VIEWS OF THE DRAWING

The present invention is described in fill and enabling details by reference to the accompanying drawings in which:

FIG. 1 is a perspective view of two sheets of drywall abutting with a portion of my new Ultimate Drywall tape permanently stuck to the seam of two drywall sheets. Also, showing is the thicker center portion of the tape demonstrating how it fills out the entire seam independently and thoroughly without the aid of any filling agents.

FIG. 2 is a prospective view of my new tape revealing the actual edge looking on it horizontally the same as looking on a piece of 2×4 lumber to view the grain of the wood or like looking at the point of your index finger pointing to your face.

FIG. 3 is a prospective view of my new tape with a roll having the backing peeled back being ready for installation to a drywall seam. It goes without question that my new drywall tape is definitely the Ultimate Drywall Tape to keep up with the demands for new homes, office buildings and industrial buildings in this fast pace building industry. There is a definite need for more efficient materials to keep up with construction demands in rapid finishing of drywall construction. I am sure the new Ultimate Drywall Tape is the answer to quicker installation, to a stronger seam by virtue of its thicker center portion. Also, an extremely quicker finish seam because of the relatively small amount of drywall compound it takes to taper off the edges of the tape as they meet with flat surfaces of the drywall on either sides. Overall, we are looking at a new generation of not only quicker drywall finishing, but also a stronger drywall because of the thicker center portion of the new tape that fills out the drywall seam independently and also the very potent self-adhesive that bonds the sheets permanently and definitely the fastest method ever for drywall construction. I am thoroughly convinced that the Ultimate Drywall tape is the answer to a more efficient drywall finish and a money saver for the construction industry.

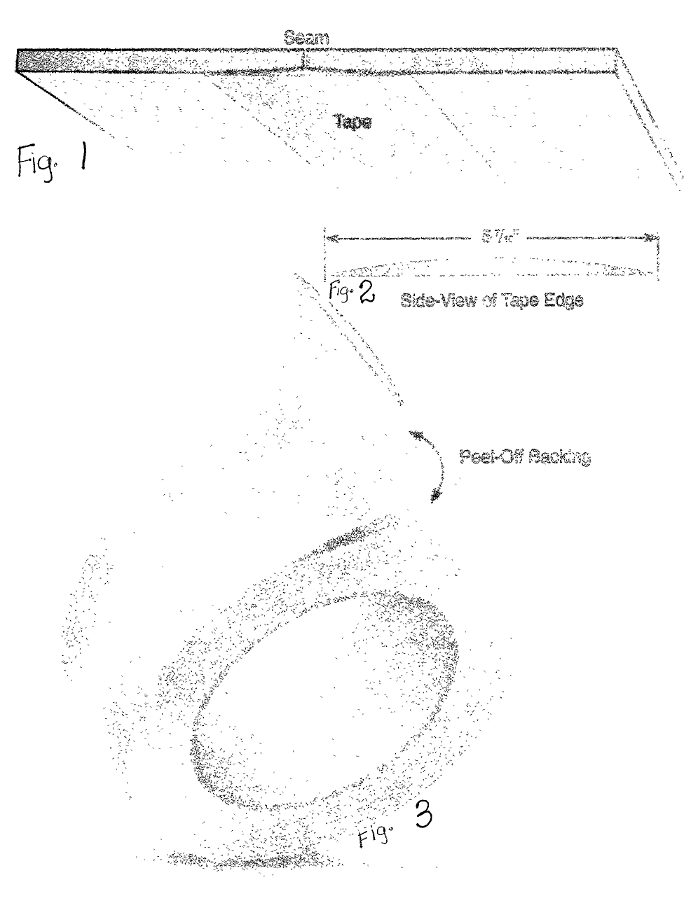

### DETAILED DESCRIPTION OF THE INVENTION

Referring to the drawing in particular, the invention embodied therein a drywall tape (2) generally designated which is advantageously supplied on a roll of tape (2) containing preferably 150 to 250 feet of tape. A 150-foot roll may be for home use, for example, and a 250-foot roll for commercial use.

The tape is made of repulpable paper, pulp paper or other porous or wettable material, which is compatible with wet compound or plaster and the compound or plaster after it has dried. The tape advantageously has a width (4) of about 5 7/16 inch and has a solid finish not perforated and also a thicker center portion (6) that fills out the seam (8) thoroughly and independently of any other filling agents. While the tape (2) maintains a thicker center portion (6) that fills out the entire seam (8), the tape (2) consistently maintains this unique attribute throughout the entire length of the tape (2). The backing material (10) may be crafted silicon release wax paper or any other which can temporarily adhere to the adhesive but can be in an easy fashion peeled back for rapid installation of the tape (2). The adhesive (12) can be applied to the paper tape (2) by application of the adhesive (12) to the backing (10) followed by pressing the tape (2) against the backing (10). The adhesive (12) is then transferred from the backing (10) to the paper tape (2) where it permanently adheres to the paper tape (2) and temporarily to the backing (10).

In the installation of the tape to the drywall seam (14), the backing (10) is being peeled off and the tape (2) is being installed to the seam (8) where the adhesive (12) make a permanent bond with the flat surface of the drywall (14) that forms the wall expanse (16).

The tape has been subjected to only one field test. It performs flawlessly both with bonding potency and filling ability, i.e., the center portion of the tape that is thicker filled out the seam extremely well and with record timing. It has been checked several times over a period of two weeks to verify its ability to perform as was expected, not to shrink nor lose adhesion. All check results positive.

It is quite evident that with this type of quick installation of drywall tape and the superior quality, the construction industry will save a tremendous amount of time that will transfer in huge monetary savings.

The above description and examples should not be construed as limitations on the scope of the invention. Many other variations are possible. Accordingly, the scope of the invention is determined by the claims and the legal equivalents.

What I claim as my invention is:

1) A drywall tape that has the ability to fill out a drywall seam totally without any other filling agents. Said tape also adheres to the drywall seam permanently.

2) Tape according to claim 1 where tape having the ability to fill out a drywall seam totally and independently of any other filling agents

3) Tape according to claim 2 where tape having the ability to fill out a drywall seam totally and independently. Said tape has a thicker center portion that fills out the drywall seam

4) Tape according to claim 1 where tape has a thicker center portion that fills out the drywall seam. Said tape center portion is about 1/16 inch at the center of said tape.

5) Tape according to claim 4 where tape's center portion is about 1/16 inch. Said tape tapers off thinner as said tape rises from the center of a drywall seam toward the flat surface of a drywall.

6) Tape according to claim 2 where tape has the ability to bond permanently with a drywall seam.

7) Tape according to claim 2 where tape has the ability to bond permanently with a drywall seam a layer of self adhesive is applied to the inner surface of said tape allowing permanent bonding with a drywall seam to occur.
